(19) United States
(12) Patent Application Publication
(10) Pub. No.: US 2025/0216861 A1
(43) Pub. Date: Jul. 3, 2025

(54) METHOD, SYSTEM AND COMPUTER PROGRAM PRODUCT FOR DETERMINING A ROUTE FOR A CONTAINER HANDLING VEHICLE

(71) Applicant: AutoStore Technology AS, Nedre Vats (NO)

(72) Inventors: Øystein Myrmo, Jar (NO); Vegard Syre-Aaker, Asker (NO)

(21) Appl. No.: 18/850,874

(22) PCT Filed: Mar. 27, 2023
(86) PCT No.: PCT/EP2023/057835

§ 371 Date: Sep. 25, 2024

(30) Foreign Application Priority Data
Mar. 30, 2022 (NO) 20220391

(51) Int. Cl. G05D 1/644; B61C 13/00; B61L 27/16; B65G 1/04; G01C 21/20; G05D 101/00; G05D 105/28

(52) U.S. Cl. CPC G05D 1/644; B61C 13/00; B61L 27/16; B65G 1/0464; G01C 21/20; B61L 2201/00; G05D 2101/22; G05D 2105/28

(57) ABSTRACT

System, method, and computer program product for determining a route for a container handling vehicle operating on a rail system of an automatic grid-based storage and retrieval system. The method comprising creating a model of the rail system representing the rail system as a finite set of non-overlapping rectangular first zones in a first direction, and a finite set of non-overlapping rectangular second zones in a second direction, wherein the zones are positioned around grid positions that are not accessible by the container handling vehicle, determining overlap information indicative of one or more regions of the rail system in which there is an overlap between a zone of the finite set of first zones and a zone of the finite set of second zones, determining grid position zone information by, for each grid position determining in which of the finite set of first zones and/or the finite set of second zones the grid position is located, receiving a request for a route for at least one container handling vehicle from a first grid position to a second grid position; and determining the route using the model of the rail system.

### FIELD OF THE INVENTION

The present invention relates to an automated storage and retrieval system for storage and retrieval of containers, in particular to a method, system and computer program product for determining a route for a container handling vehicle operating on a rail system of the an automated storage and retrieval system.

### BACKGROUND AND PRIOR ART

FIG. 1 discloses a prior art automated storage and retrieval system 10 with a framework structure 100 and FIGS. 2, 3 and 4 disclose three different prior art container handling vehicles 201,301,401 suitable for operating on such a system 10.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 10 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 10, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 10, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 10 comprises a control system 121 which typically is computerized and which typically comprises a database for keeping track of the storage containers 106.

When estimating costs to solve the assignment problem it is important to have good estimations to assign the tasks in an optimal order. A simple way of doing this is to use the Manhattan distance/time as an estimation. One drawback of using Manhattan distance is that the geometry of the grid is not taken into account, so that in some cases the estimation can be very inaccurate, for example across a gap or through a column in the grid. Performing a full A* routing algorithm for all container handling vehicles for all tasks to be performed is in general too time consuming for real time computer processing, especially for large grids.

It is therefore a need in the art for a method of determining routes of a container handling vehicle that is very fast in most cases, while also being accurate in all cases.

### SUMMARY OF THE INVENTION

The present invention is set forth and characterized in the independent claims, while the dependent claims describe other characteristics of the invention.

In one aspect, the invention is related to a method of determining a route for a container handling vehicle operating on a rail system of an automatic grid-based storage and retrieval system comprising a framework structure including the rail system, the rail system comprising a first set of parallel rails in a first direction, and a second set of parallel rails arranged in a second direction which is perpendicular to the first direction, the rail system defining a plurality of grid positions each being identifiable by a first coordinate in the first direction and a second coordinate in the second direction, the method comprising, using a control system communicating with a vehicle controller in the container handling vehicle:
creating a model of the rail system, comprising the steps of
representing the rail system as a finite set of non-overlapping rectangular first zones of grid positions, each first zone latitudinally extending in the first direction, and a finite set of non-overlapping rectangular second zones of grid positions, each second zone longitudinally extending in the second direction, wherein the zones are positioned around grid positions that are not accessible by the container handling vehicle,
determining overlap information, wherein the overlap information is indicative of one or more regions of the rail system in which there is an overlap between a zone of the finite set of first zones and a zone of the finite set of second zones,
determining grid position zone information by, for each grid position, determining in which of the finite set of first zones and/or the finite set of second zones the grid position is located,
receiving a request for a route for at least one container handling vehicle from a first grid position to a second grid position, and
determining the route for the at least one container handling vehicle from the first grid position to the second grid position using the model of the rail system.

An advantage of the first aspect of the invention is that it provides a method of determining routes of a container handling very fast in most cases, while also being accurate in all cases.

The method is also very well suited for CPU/GPU parallelization as all the information within the model is constant once created.

One advantageous usage of the method is to optimize the position of available container handling vehicles on the rail system. By using the overlap information, cells belonging to two zones may be easily identified. These cells represent intersections in the rail system. Instructing available container handling vehicles to wait in those intersections provides better usage of the container handling vehicles since standing in an intersection result in more Manhattan routes.

Another advantageous usage is to use the method to find segmentations of the rail system. If there are parts of the rail system that cannot be reached by other parts of the rail system, this may be found from the overlap information by setting it up as an undirected graph and create minimum spanning trees on the graph. If there are more than one minimum spanning tree, there are segmentations in the grid, which can then easily be extracted.

In one embodiment, the method may comprise, determining, using the grid position zone information, that the route is a straight line between the first grid position and the second grid position when the first grid position and the second grid position are in the same zone and share either the same first coordinate or the same second coordinate.

In one embodiment, the method may comprise, determining, using the grid position zone information, that the route is a single-turn Manhattan route between the first grid position and the second grid position when the first grid position and the second grid position are in the same zone and share neither the same first coordinate nor the same second coordinate.

In one embodiment, the method may comprise, determining, using the grid position zone information and the overlap information, that the route is a single-turn Manhattan route between the first grid position and the second grid position when the first grid position and the second grid position are in different and overlapping zones.

In one embodiment, the method may comprise, using the set of first zones, the set of second zones and the overlap information to generate a zone graph comprising nodes and edges, wherein the nodes represent the finite set of first zones and the finite set of second zones, and the edges represent the overlap information.

In one embodiment, the method may comprise, determining, using the grid position zone information and the overlap information, that the first grid position and the second grid position are not in the same zone and not in overlapping zones, and determining the route between the first grid position and the second grid position using a graph traversal and path search algorithm on the zone graph. The graph traversal and path search algorithm may in one embodiment be an A* algorithm.

In one embodiment, representing the rail system as the set of first zones and the set of second zones may comprise:
defining the grid positions that are not accessible by the container handling vehicle as blocked cells and grid cells accessible for the container handling vehicle as open cells,
determining a first set of non-overlapping rectangular regions of grid positions, each first region latitudinally extending in the first direction and defining the largest possible rectangle of continuous open cells uninterrupted by at least one blocked cell,
determining a second set of non-overlapping rectangular regions of grid positions, each second region longitudinally extending in the second direction and defining the largest possible rectangle of continuous open cells uninterrupted by at least one blocked cell,
determining the finite set of first zones by removing any region of the first set of regions that falls completely within a region of the second set of regions; and
determining the finite set of second zones by removing any region of the second set of regions that falls completely within a region of the first set regions.

In one embodiment, the step of determining the first set of regions may comprise determining continuous sections of open cells extending in the first direction that are uninterrupted by a blocked cell, each continuous section having a start position having a first coordinate and a length defined by the number of open cells uninterrupted by a blocked cell, wherein the largest possible rectangle of continuous open cells latitudinally extending in the first direction uninterrupted by a blocked cell comprises either a number of adjacent continuous sections having a start position with the same first coordinate and the same length, or a single vertical continuous section, and the step of determining the second set of regions comprises determining continuous sections of open cells extending in the second direction that are uninterrupted by a blocked cell, each continuous section having a start position having a second coordinate and a length defined by the number of open cells uninterrupted by a blocked cell, wherein the largest possible rectangle of continuous open cells longitudinally extending in the second direction uninterrupted by a blocked cell comprises either a number of adjacent continuous sections having a start position with the same second coordinate and the same length, or a single horizontal continuous section.

In one embodiment, defining grid positions that are not accessible by the container handling vehicle may comprise determining one or more grid positions that have at least one physical dimension that is smaller than at least one physical dimension of the container handling vehicle, and identifying the one or more grid positions as being not accessible by the container handling vehicle.

In one embodiment, the method may comprise
receiving a request for a route for a plurality of container handling vehicles from a plurality of first grid position to a second grid position; —determining the fastest route for each of the plurality of container handling vehicles from the plurality of first grid position to the second grid position using the model of the rail system,
determining based on the fastest route for each of the plurality container handling vehicles an optimal container handling vehicle of the plurality container handling vehicles for moving to the second grid position, and
instructing the optimal container handling vehicle to move to the second grid position.

In a second aspect, the invention concerns a system of determining a route for a container handling vehicle operating on a rail system of an automatic grid-based storage and retrieval system comprising a framework structure including the rail system, the rail system comprising a first set of parallel rails in a first direction, and a second set of parallel rails arranged in a second direction which is perpendicular to the first direction, the rail system defining a plurality of grid positions each being identifiable by a first coordinate in the first direction and a second coordinate in the second direction,
a control system adapted to communicate with a vehicle controller in the container handling vehicle, wherein the control system is adapted to creating a model of the rail system, comprising the steps of
representing the rail system as a finite set of non-overlapping rectangular first zones of grid positions, each first zone latitudinally extending in the first direction, and a finite set of non-overlapping rectangular second zones of grid positions, each second zone longitudinally extending in the second direction, wherein the zones are positioned around grid positions that are not accessible by the container handling vehicle,
determining overlap information, wherein the overlap information is indicative of one or more regions of the rail system in which there is an overlap between a zone of the finite set of first zones and a zone of the finite set of second zones,
determining grid position zone information by, for each grid position, determining in which of the finite set of first zones and/or the finite set of second zones the grid position is located,
receiving a request for a route for at least one container handling vehicle from a first grid position to a second grid position, and
determining the route for the at least container handling vehicle from the first grid position to the second grid position using the model of the rail system.

In one embodiment, the system may be adapted to determining, using the grid position zone information, that the route is a straight line between the first grid position and the second grid position when the first grid position and the second grid position are in the same zone and share either the same first coordinate or the same second coordinate.

In one embodiment, the system may be adapted to determining, using the grid position zone information, that the route is a single-turn Manhattan route between the first grid position and the second grid position when the first grid position and the second grid position are in the same zone and share neither the same first coordinate nor the same second coordinate.

In one embodiment, the system may be adapted to determining, using the grid position zone information and the overlap information, that the route is a single-turn Manhattan route between the first grid position and the second grid position when the first grid position and the second grid position are in different and overlapping zones.

In one embodiment, the system may be adapted to, using the set of first zones, the set of second zones and the overlap information to generate a zone graph comprising nodes and edges, wherein the nodes represent the finite set of first zones and the finite set of second zones, and the edges represent the overlap information.

In one embodiment, the system may be adapted to determining, using the grid position zone information and the overlap information, that the first grid position and the second grid position are not in the same zone and not in overlapping zones, and determining the route between the first grid position and the second grid position using a graph traversal and path search algorithm on the zone graph. The graph traversal and path search algorithm may in one embodiment be an A* algorithm.

In one embodiment, representing the rail system as the set of first zones and the set of second zones may comprise:
defining the grid positions that are not accessible by the container handling vehicle as blocked cells and grid cells accessible for the container handling vehicle as open cells,
determining a first set of non-overlapping rectangular regions of grid positions, each first region latitudinally extending in the first direction and defining the largest possible rectangle of continuous open cells uninterrupted by at least one blocked cell,
determining a second set of non-overlapping rectangular regions of grid positions, each second region longitudinally extending in the second direction and defining the largest possible rectangle of continuous open cells uninterrupted by at least one blocked cell,
determining the finite set of first zones by removing any region of the first set of regions that falls completely within a region of the second set of regions, and
determining the finite set of second zones by removing any region of the second set of regions that falls completely within a region of the first set regions.

In one embodiment, the step of determining the first set of regions may comprise determining continuous sections of open cells extending in the first direction that are uninterrupted by a blocked cell, each continuous section having a start position having a first coordinate and a length defined by the number of open cells uninterrupted by a blocked cell, wherein the largest possible rectangle of continuous open cells latitudinally extending in the first direction uninterrupted by a blocked cell comprises either a number of adjacent continuous sections having a start position with the same first coordinate and the same length, or a single vertical continuous section, and the step of determining the second set of regions comprises determining continuous sections of open cells extending in the second direction that are uninterrupted by a blocked cell, each continuous section having a start position having a second coordinate and a length defined by the number of open cells uninterrupted by a blocked cell, wherein the largest possible rectangle of continuous open cells longitudinally extending in the second direction uninterrupted by a blocked cell comprises either a number of adjacent continuous sections having a start position with the same second coordinate and the same length, or a single horizontal continuous section.

In one embodiment, defining grid positions that are not accessible by the container handling vehicle may comprise determining one or more grid positions that have at least one physical dimension that is smaller than at least one physical dimension of the container handling vehicle, and identifying the one or more grid positions as being not accessible by the container handling vehicle.

In one embodiment, the system may be adapted to
receiving a request for a route for a plurality of container handling vehicles from a plurality of first grid position to a second grid position,
determining the fastest route for each of the plurality of container handling vehicles from the plurality of first grid position to the second grid position using the model of the rail system,
determining based on the fastest route for each of the plurality container handling vehicles an optimal container handling vehicle of the plurality container handling vehicles for moving to the second grid position, and
instructing the optimal container handling vehicle to move to the second grid position.

In a third aspect the invention is directed to computer program product for a control system in the system of the second aspect, wherein the computer program product comprising instructions that when performed on the control system performs the method according to the first aspect.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a schematic top view of an exemplary rail system.

FIGS. 6A and 6B are a schematic illustration of a method according to an embodiment of the present invention.

FIGS. 7A and 7B are a schematic illustration of a method according to an embodiment of the present invention.

FIGS. 8A and 8B are a schematic illustration of a method according to an embodiment of the present invention.

FIGS. 9A and 9B are a schematic illustration of a method according to an embodiment of the present invention.

FIG. 10 is a schematic illustration of a method according to an embodiment of the present invention.

FIG. 11 is a schematic illustration of a shortest route according to an embodiment of the present invention.

FIG. 12 is a schematic illustration of a shortest route according to an embodiment of the present invention.

FIG. 13 is a schematic illustration of a shortest route according to an embodiment of the present invention.

FIG. 14 is a schematic illustration of a shortest route according to an embodiment of the present invention.

FIG. 15 is a flowchart of a method according to an embodiment of the present invention.

FIG. 16 is a schematic illustration of a zone graph according to an embodiment of the present invention.

FIG. 17 is a schematic illustration of a shortest route according to an embodiment of the present invention.

FIG. 18 is a schematic illustration of a shortest route according to an embodiment of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

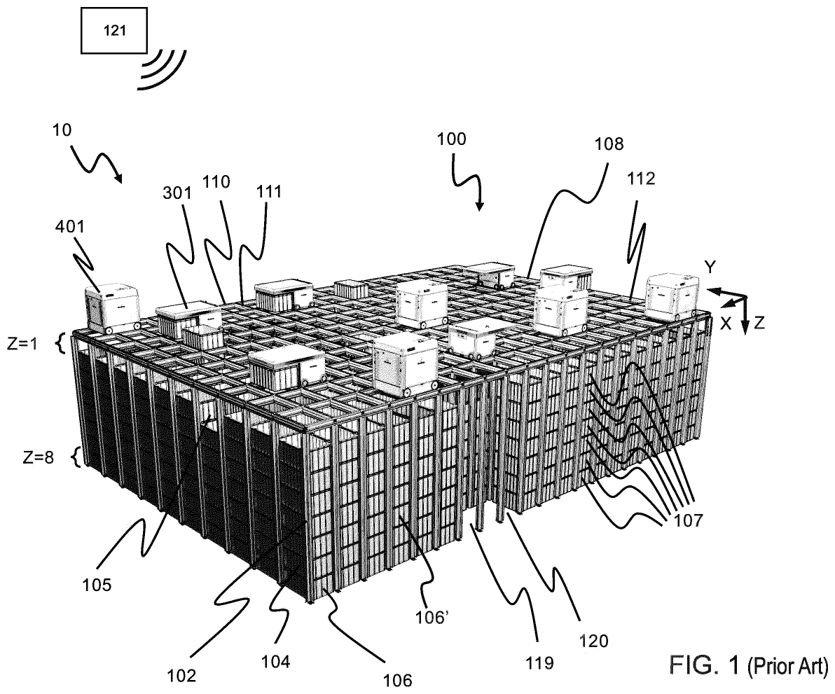

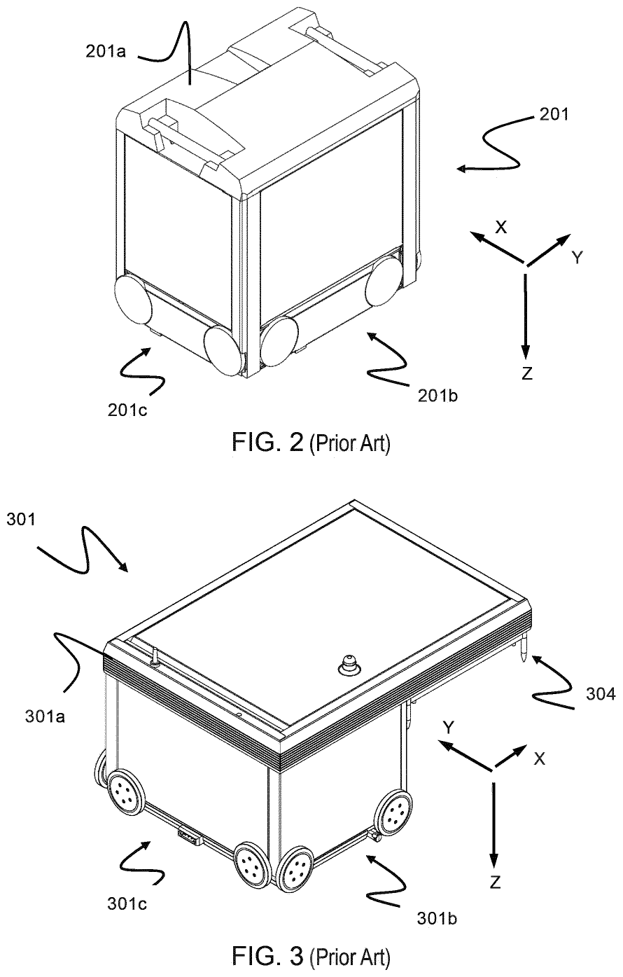

The framework structure 100 of the automated storage and retrieval system 10 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

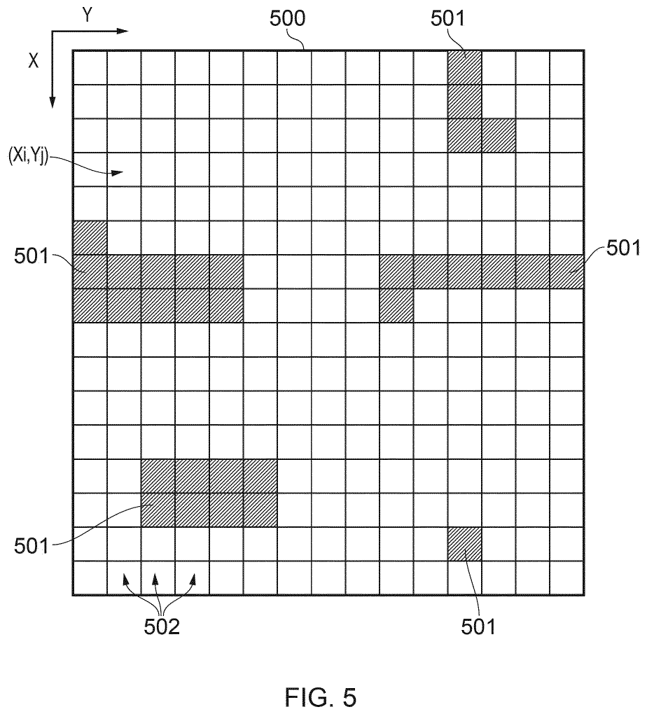

One embodiment of the automated storage and retrieval system according to the invention will now be discussed in more detail with reference to FIGS. 5-18.

FIG. 5 is a schematic top view of an exemplary rail system 500. The rail system 500 comprising a first set of parallel rails in a first direction, and a second set of parallel rails arranged in a second direction Y which is perpendicular to the first direction X. The rail system 500 defines a plurality of grid positions (Xi,Yj) each being identifiable by a first coordinate Xi in the first direction X and a second coordinate Yj in the second direction Y. FIG. 5 illustrates one exemplary grid position (Xi,Yj), where Xi=4 and Yj=2. The illustrated grid positions (Xi,Yj) are for simplicity square, however, in typical implementations such as the rail system 108 of FIG. 1, the grid positions (Xi,Yj) or cells, are rectangular. For rectangular cells, the time to drive over a cell is different in the x- and the y-direction.

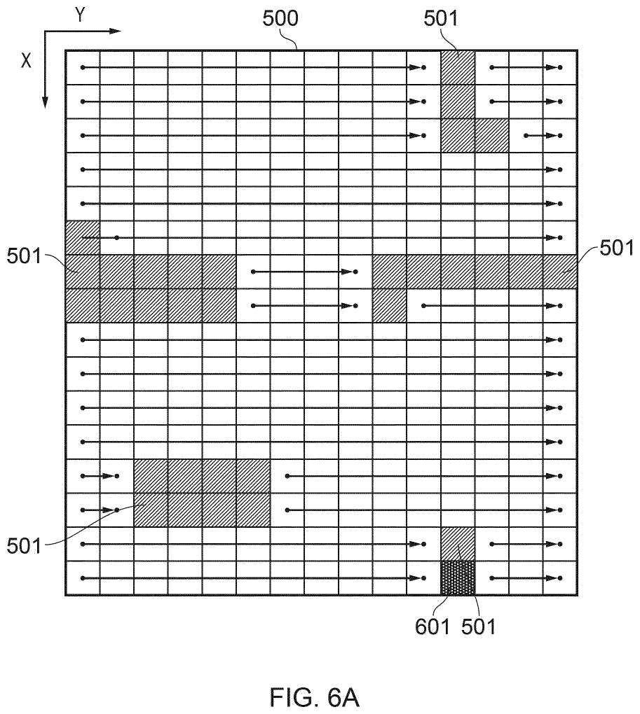

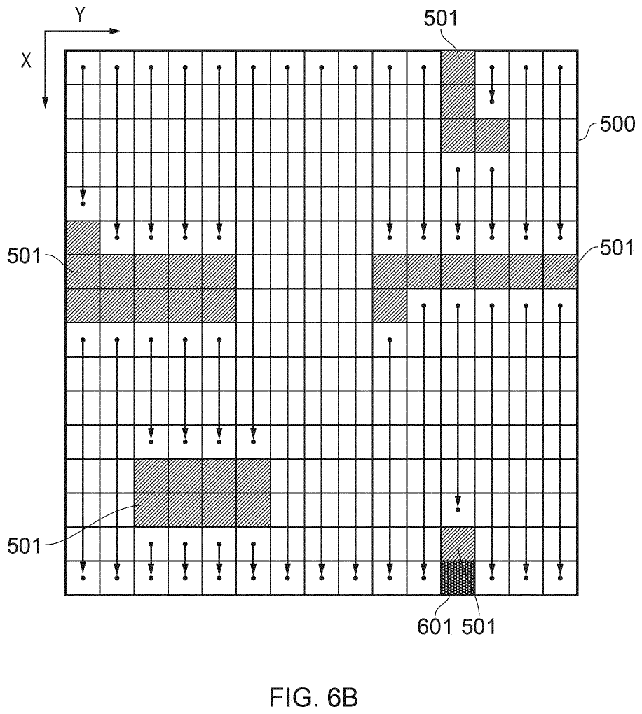

Grid positions (Xi,Yj) that are permanently inaccessible for a container handling vehicle 201,301,401 are referred to as permanently blocked cells 501. The permanently blocked cells 501 are grid positions that are not physically accessible for the container handling vehicles due to the physical layout of a warehouse, such as a wall, a pillar, a low ceiling or other reasons physical reasons for missing cells. In addition to the permanently blocked cells there may be grid positions (Xi,Yj) that have at least one physical dimension that is smaller than at least one physical dimension of the container handling vehicle 201,301,401 operating on the rail system 500, such that the grid position is not physically accessible for the container handling vehicle 201,301,401. One such grid position 601 is illustrated in FIGS. 6-14, 17 and 18.

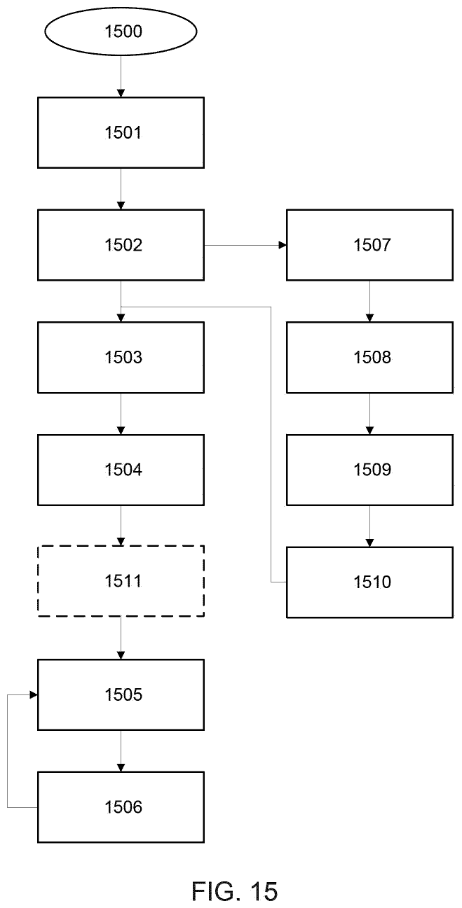

FIG. 15 illustrates a flowchart of a method 1500 of determining a route for a container handling vehicle 201,301,401 operating on the rail system 500 illustrated in FIG. 5. The method comprises, using a control system communicating with a vehicle controller in the container handling vehicle 201,301,401, creating a model 1501 of the rail system 500, receiving a request for a route 1505 for at least one container handling vehicle 201,301,401 from a first grid position to a second grid position, and determining the route 1506 for the at least one container handling vehicle 201,301,401 from the first grid position to the second grid position using the model of the rails system 500.

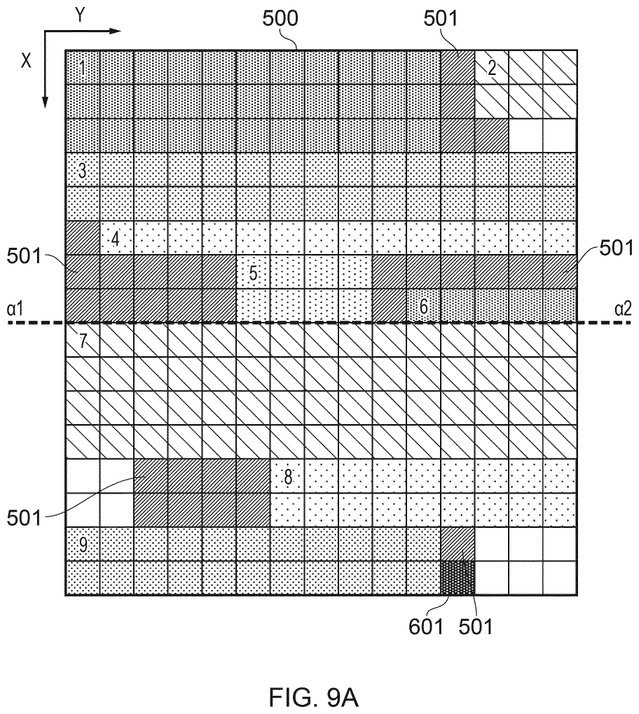

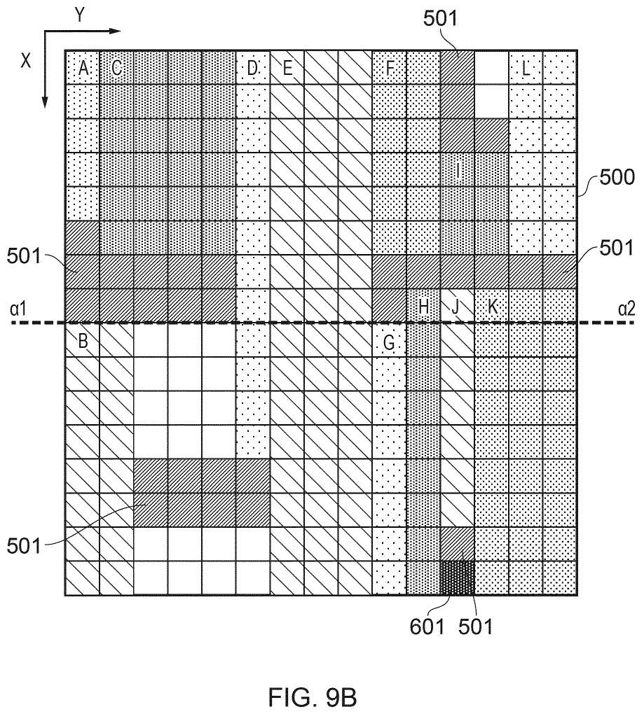

With additional reference to FIGS. 9A and 9B, creating the model 1501 of the rail system 500 comprises the step of representing the rail system 500 as a finite set of non-overlapping rectangular first zones 1502 of grid positions A, B, C, D, E, F, G, H, I, J, K, L, each first zone latitudinally extending in the first direction X, and a finite set of non-overlapping rectangular second zones of grid positions 1, 2, 3, 4, 5, 6, 7, 8, 9, each second zone longitudinally extending in the second direction Y, wherein the zones are positioned around grid positions 501, 601 that are not accessible by the container handling vehicle 201,301,401.

Then in a following step, determining overlap information 1503, wherein the overlap information is indicative of one or more regions of the rail system in which there is an overlap between a zone of the finite set of first zones A, B, C, D, E, F, G, H, I, J, K, L and a zone of the finite set of second zones 1, 2, 3, 4, 5, 6, 7, 8, 9. For example, using the information from FIGS. 9A and 9B it is clear that zone 1 overlaps zone A, C, D, E and F, zone 2 overlaps zone L, zone 3 overlaps zone A, C, D, E, F, I and L, and so on. This information may be stored in an array and it is not modified once created.

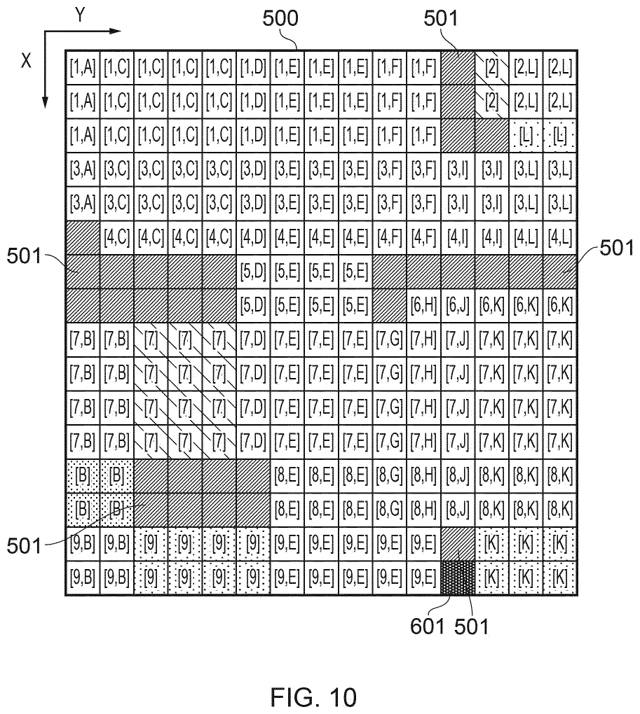

Then in a following step, determining grid position zone information 1504 by, for each grid position (Xi,Yj), determining in which of the finite set of first zones A, B, C, D, E, F, G, H, I, J, K, L and/or the finite set of second zones 1, 2, 3, 4, 5, 6, 7, 8, 9 the grid position (Xi,Yj) is located. The grid position information may be stored in a matrix or similar structure and is not modified once created. FIG. 10 illustrates the zones all of the grid positions belong to. A grid position belongs to minimum one zone and maximum two zones. This allows for a sparse saving of data and fast lookup by grid position.

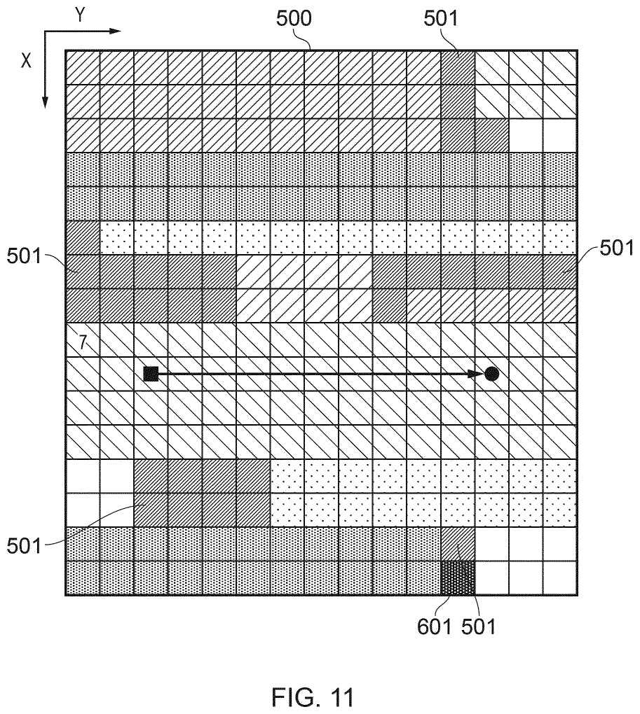

The steps of receiving and determining the route for the container handling vehicle 201,301,401 from a first grid position to a second grid position using the model of the rail system 500 is described with reference to FIGS. 11-14 and 17.

Now with reference to FIGS. 15, in one embodiment, the step of representing the rail system 500 as the set of first zones A, B, C, D, E, F, G, H, I, J, K, L and the set of second zones 1, 2, 3, 4, 5, 6, 7, 8, 9 comprises the step of defining the grid positions (Xi,Yj) that are not accessible 1507 by the container handling vehicle 201,301,401 as blocked cells 501, 601 and grid cells accessible for the container handling vehicle 201,301,401 as open cells 502. Blocked cells 501, 601 may be permanently blocked cells 501 or may be grid positions 601 that have at least one physical dimension that is smaller than at least one physical dimension of the container handling vehicle 201,301,401 operating on the rail system 500 such that the container handling vehicle 201,301,401 cannot pass in at least one direction.

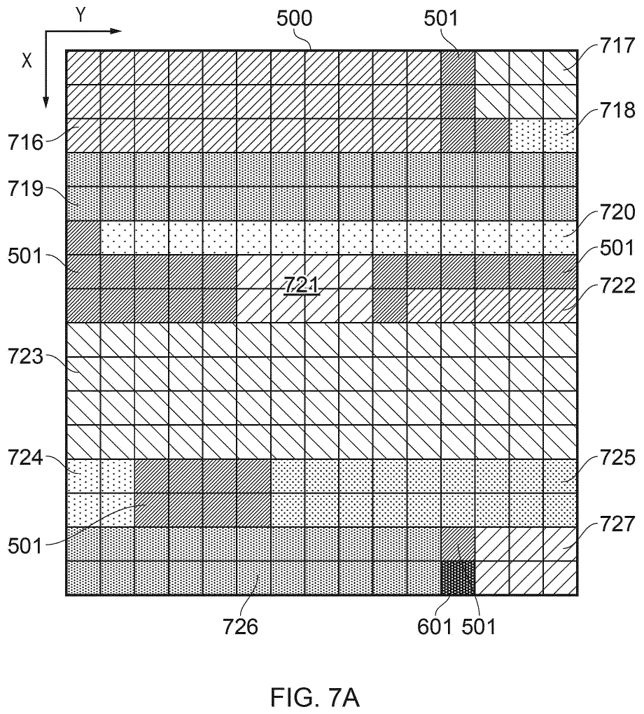

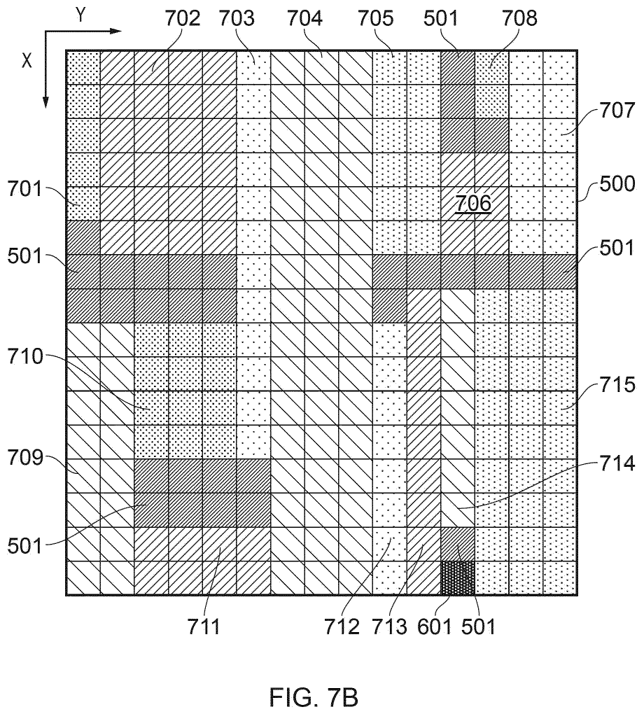

Then in a following step, illustrated in FIGS. 7A and 7B, determining a first set of non-overlapping rectangular regions 1508 of grid positions 701, 702, 703, 704, 705, 706, 707, 708, 709, 710, 711, 712, 713, 714, 715, each first region latitudinally extending in the first direction X and defining the largest possible rectangle of continuous open cells uninterrupted by at least one blocked cell 501, 601, and determining a second set of non-overlapping rectangular regions 1509 of grid positions 716, 717, 718, 719, 720, 721, 722, 723, 724, 725, 726, 727, each second region longitudinally extending in the second direction Y and defining the largest possible rectangle of continuous open cells uninterrupted by at least one blocked cell 501, 601. The term continuous open cells denote the largest extent of side-by-side open cells in a given direction.

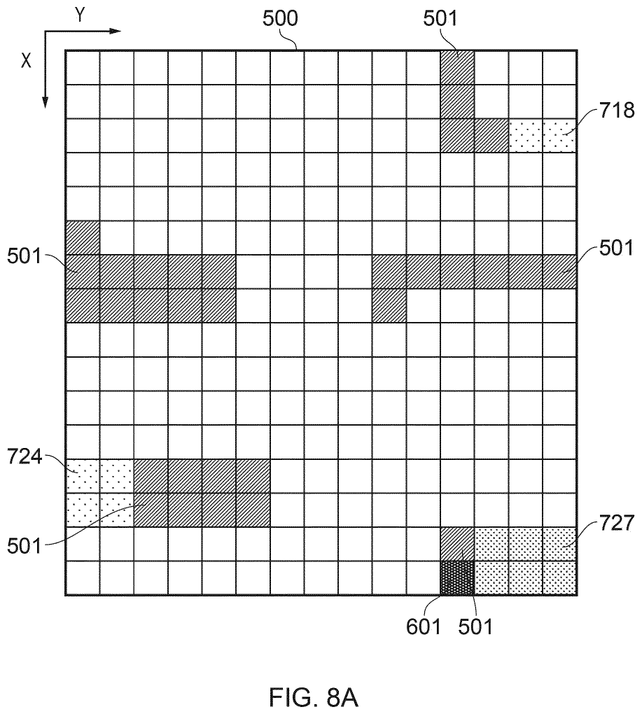

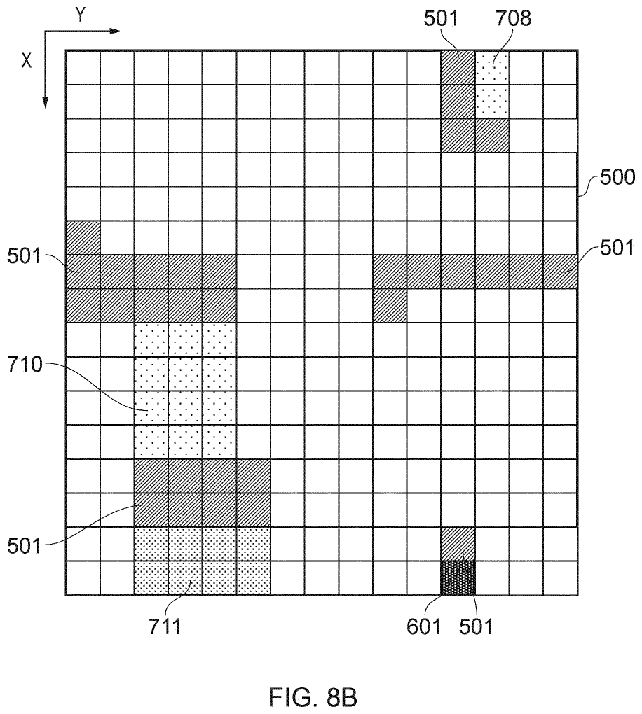

Then in a following step 1510, illustrated in FIGS. 8A and 8B, determining the finite set of first zones A, B, C, D, E, F, G, H, I, J, K, L by removing any region 708, 710, 711 of the first set of regions that falls completely within a region of the second set of regions 717, 723, 726, and determining the finite set of second zones 1, 2, 3, 4, 5, 6, 7, 8, 9 by removing any region 718, 724, 727 of the second set of regions that falls completely within a region of the first set regions 707, 709, 715.

Regions that fall completely withing another region are redundant. Removing these redundant regions is important for several reasons such as to make any A* route search efficient, and that moving from one zone to another zone implies making a turn.

Now with reference to FIG. 15, in one embodiment, the step of determining the first set of regions 1508 comprises, illustrated in FIG. 6 B, determining continuous sections of open cells 502 extending in the first direction X that are uninterrupted by a blocked cell 501, 601, each continuous section having a start position having a first coordinate Xi and a length defined by the number of open cells 502 uninterrupted by a blocked cell 501, 601, and as illustrated by FIG. 7B, the largest possible rectangle of continuous open cells 502 latitudinally extending in the first direction X uninterrupted by a blocked cell 501, 601 comprises either a number of adjacent continuous sections having a start position with the same first coordinate Xi and the same length, or a single vertical continuous section. Similarly, the step of determining the second set of regions 1509 comprises, illustrated in FIG. 6A, determining continuous sections of open cells 502 extending in the second direction Y that are uninterrupted by a blocked cell 501, 601, each continuous section having a start position having a second coordinate Yj and a length defined by the number of open cells 502 uninterrupted by a blocked cell 501, 601, and as illustrated by FIG. 7A, the largest possible rectangle of continuous open cells 502 longitudinally extending in the second direction Y uninterrupted by a blocked cell 501, 601 comprises either a number of adjacent continuous sections having a start position with the same second coordinate Yi and the same length, or a single horizontal continuous section.

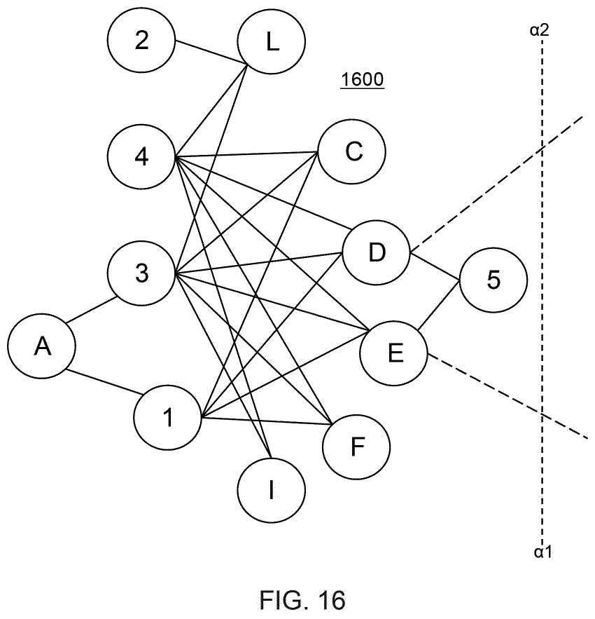

In one embodiment, the method comprises using the set of first zones, the set of second zones and the overlap information to generate a zone graph 1511 comprising nodes and edges, wherein the nodes represent the finite set of first zones A, B, C, D, E, F, G, H, I, J, K, L and the finite set of second zones 1, 2, 3, 4, 5, 6, 7, 8, 9, and the edges represent the overlap information. FIG. 16 is an exemplary schematic illustration of a zone graph 1600 of the zones and edges of the rail system 500 above the dashed line α1-a2 shown in FIGS. 9A and 9B. The circles represent the zones A, C, D, E, F, I, L, 1, 2, 3, 4, 5 and the interconnecting lines the edges. The stippled edges extending from zones D and F illustrates overlap to zones below the dashed line α1-a2 in FIGS. 9A and 9B.

A request for a route 1505 for the container handling vehicle 201,301,401 from a first grid position to a second grid position comprises the first grid position, i.e. the start position of the container handling vehicle 201,301,401, and the second grid position, i.e. the end position of the container handling vehicle 201,301,401. The request may also comprise information about the container handling vehicle 201,301,401 such as robot type, current direction of movement, and orientation of the container handling vehicle 201,301,401 on the rail system 500, and information about the rail system 500, such as cell sizes to calculate movement times. The request for the route is for the optimal route from the first grid position to the second grid position, e.g. the fastest route. Alternatively, instead of requesting a route, the request is for minimum cost. The request is the same as for a route, but instead of returning a route, the request returns the cost/duration of the optimal route.

When determining the fastest route, the method of the present invention distinctly handles three main cases: straight routes, Manhattan routes and routes through more than two zones.

Using the grid position zone information it may be determined that the fastest route is a straight line between the first grid position and the second grid position when the first grid position and the second grid position are in the same zone and share either the same first coordinate (Xi) or the same second coordinate (Yj). This guarantees that there is no blockage between the start and end positions. If only considering that the first grid position and the second grid position share either the same first coordinate (Xi) or the same second coordinate (Yj), there is no guarantee that the container handling vehicle can follow the route, for example if going from zone L to zone K as illustrated in FIG. 9B. FIG. 11 illustrates a straight line route between point A and B within the same zone 7.

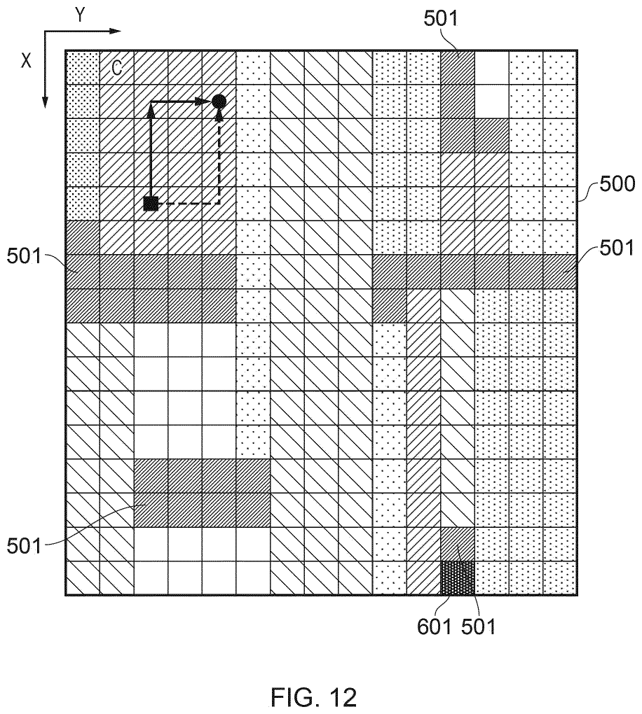

Using the grid position zone information it may be determined that the fastest route is a single-turn Manhattan route between the first grid position and the second grid position when the first grid position and the second grid position are in the same zone and share neither the same first coordinate (Xi) nor the same second coordinate (Yj). For Manhattan routes inside a single zone there are two equally optimal routes to choose from. FIG. 12 illustrates the two possibilities from A to B within zone C for a non-moving container handling vehicle.

If in either of the single zone routes cases discussed above, the container handling vehicle is moving and is currently driving past the second grid position or driving away from the second grid position, additional two turns are required to get to the second grid position, unless currently driving across the target position which requires the container handling vehicle to stop and drive straight back.

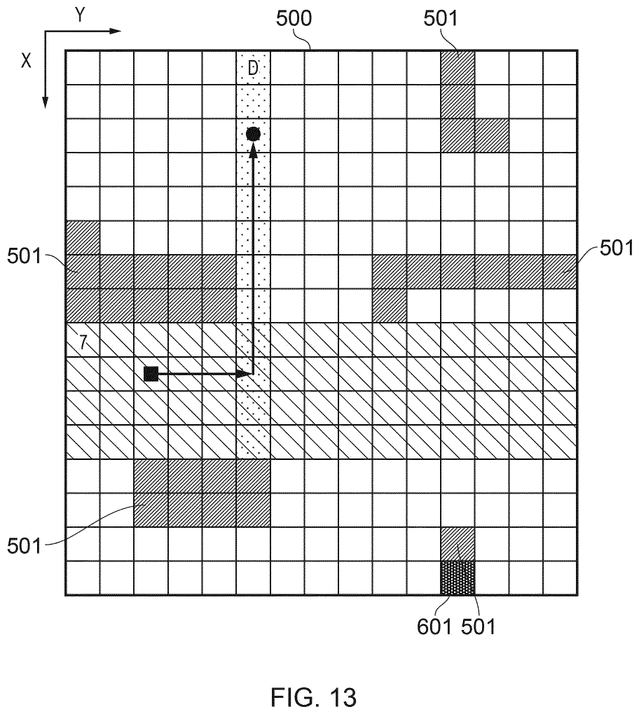

Using the grid position zone information and the overlap information it may be determined that the fastest route is a single-turn Manhattan route between the first grid position and the second grid position when the first grid position and the second grid position are in different and overlapping zones, such as illustrated in FIG. 13. In this case it is first verified that the first grid position and the second grid positions are not in the same zone.

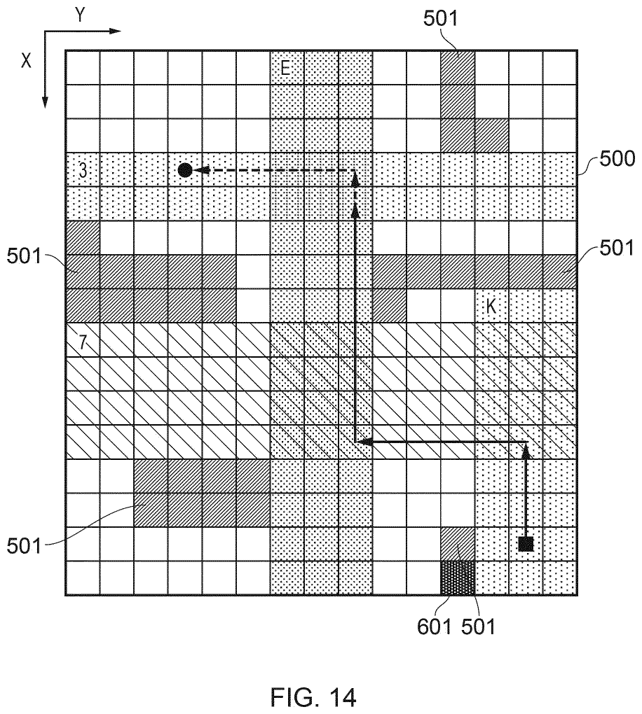

In the third case, it is determined using the grid position zone information and the overlap information, that the first grid position and the second grid position are not in the same zone and not in overlapping zones. That is, the route is passing through more than two zones. In this case the fastest route between the first grid position and the second grid position is determined using a graph traversal and path search algorithm on the zone graph 1600. Any suitable graph traversal and path search algorithm known to the skilled person may be used. A preferred graph traversal and path search algorithm is an A* algorithm. As illustrated in FIG. 14, a turn is created when moving to the first available cell inside the next zone, such that long route segments are created at the end of the route. This allows easy determination of the optimal route. This is due to the acceleration/deceleration of the container handling vehicles. Long route segments provide for less acceleration/deceleration which is more optimal. In particular, the determination considers the overlapping zones, calculates the time of going into the first available cell in the first overlapping zone from the first grid position. From the first available cell in the first overlapping zone, this is repeated for the first available cell in the second overlapping zone and so on to determine the route. The last part of the route, indicated by dashed lines, is treated separately because the container handling vehicle has required direction into the final zone. The second to last segment is therefore extended one cell in this case before turning to match the second grid position in the correct way.

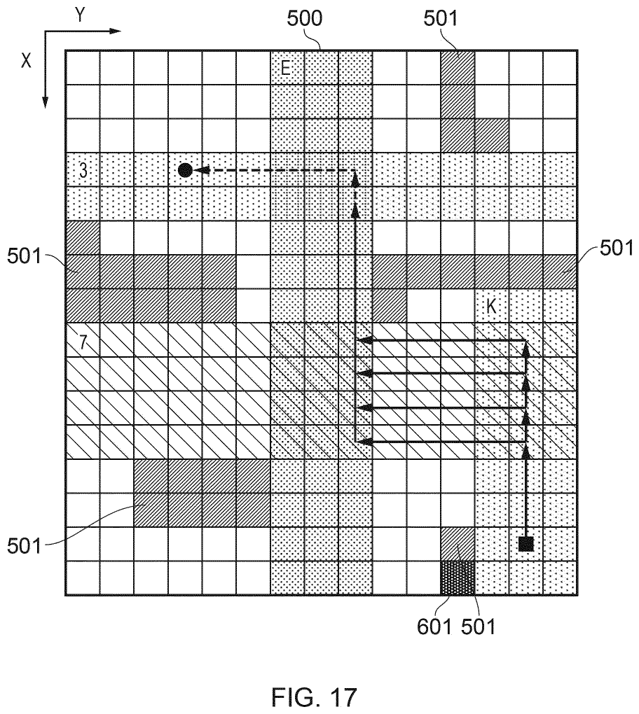

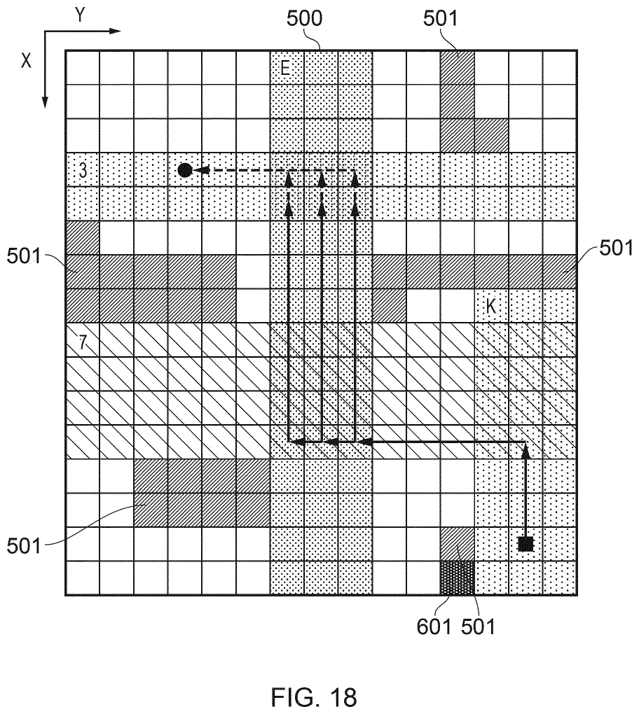

The determination of the fastest route from the first grid position to the second grid position is determined as if the container handling vehicle is alone on the rail system 500. That is, other container handling vehicles on the rail system and other temporary blockages such as top bins, are not considered. The control system 121 is in communication with a plurality of container handling vehicles 201,301,401, and has knowledge of their current positions, paths, and other temporary blockages. The control system 121 may therefore find that the determined fastest route is inaccessible because other container handling vehicles are standing on the route or because of other temporary blockages, and parts of the optimal route can be modified to take this into account. Illustrated in FIG. 17 the first route segment is set to go into the next zone 7, that is not turn at the first available cell. There are then four possibilities since the next zone 7 has height 4, which means that the segment has a slack of 4, giving 4 permutations of the route from the first grid position to the second grid position. While the first slack choice, i.e. turning at the first available cell, is the optimal one, the other routes will not be far off. Illustrated in FIG. 18, the second route segment has a slack of 3, since the next zone E has a width of 3, providing three extra route permutations on top of the existing four from the first segment. The route from the first grid position to the second grid position then has 12 permutations that can be iterated trough fast by the control system 121 to determine the most optimal of them given the other container handling vehicles and temporary blockages on the rail system 500.

The determination of the fastest route between a grid positions may be performed for a plurality of container handling vehicles, e.g. to determine which of a plurality of container handling vehicles that is the optimal container handling vehicle to perform a task, or to determine which of a plurality of tasks to be performed first. In one example a task, such as picking up storage container, is to be completed at the second grid position. In one embodiment of the method a request may be received for a route for a plurality of container handling vehicles 201,301,401 from a plurality of first grid position to the second grid position. Then the fastest route for each of the plurality of container handling vehicles 201,301,401 from the plurality of first grid position to the second grid position may be determined using the model of the rail system 500. Based on the fastest route for each of the plurality container handling vehicles 201,301,401 an optimal container handling vehicle of the plurality container handling vehicles 201,301,401 for moving to the second grid position may be determined, and the optimal container handling vehicle is instructed to move to the second grid position to perform the task.

The model of the rail system as created by the claimed method have other advantageous usages.

One advantageous usage is to optimize the position of available container handling vehicles on the rail system 500. By using the overlap information, cells belonging to two zones may be easily identified. These cells represent intersections in the rail system 500. Instructing available container handling vehicles to wait in those intersections provides better usage of the container handling vehicles since standing in an intersection result in more Manhattan routes.

Another advantageous usage is to use the model to find segmentations of the rail system 500. If there are parts of the rail system 500 that cannot be reached by other parts of the rail system 500, this may be found from the overlap information by setting it up as an undirected graph and create minimum spanning trees on the graph. If there are more than one minimum spanning tree, there are segmentations in the grid, which can then easily be extracted.

Another advantageous usage is to use the model as a filter for target cells, that is potential storage cells for returning a storage container 106 into the framework structure 100 once accessed by container handling vehicle 201, 301, 401.

In the preceding description, various aspects of the invention have been described with reference to the method 1500 performed by the control system 121. The invention further comprises a system of determining a route for a container handling vehicle 201,301,401 operating on the rail system 108,500 of an automatic grid-based storage and retrieval system 10 comprising a framework structure 100 including the rail system, the rail system 108, 500 comprising a first set of parallel rails 110 in a first direction X, and a second set of parallel rails 111 arranged in a second direction Y which is perpendicular to the first direction X, the rail system 108, 500 defining a plurality of grid positions (Xi,Yj) each being identifiable by a first coordinate Xi in the first direction X and a second coordinate Yj in the second direction Y. The system comprising the control system 121 adapted to communicate with a vehicle controller in the container handling vehicle 201,301,401. The control system 121 is adapted to the perform the method 1500 described in detail above.

The invention further comprises a computer program product for the control system 121 in the automatic grid-based storage and retrieval system 10, wherein the computer program product comprising instructions that when performed on the control system 121 performs the method 1500.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings While the invention has been described for rectangular cells, the method can be extended to any cell shape, such as triangular, rectangular, hexagonal, octagonal, and so on. Manhattan routes are also named Manhattan routes for other cell shapes. In this case, depending on the cell shape, more than two zones can overlap (e.g. three for hexagonal shapes). The method is also suitable for other types of robots than the container handling vehicles disclosed herein. As such, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

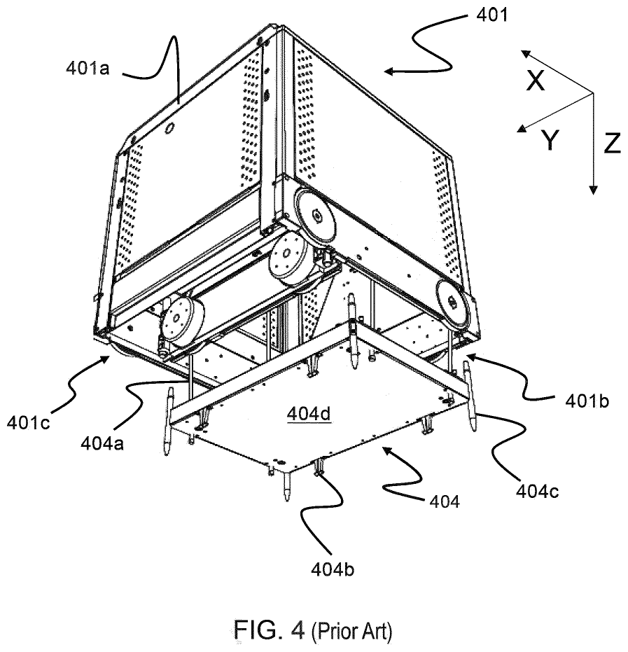

LIST OF REFERENCE NUMBERS
Prior art (FIGS. 1-4):

| | |
|---|---|
| 10 | Prior art automated storage and retrieval system |
| 100 | Framework structure |
| 102 | Upright members of framework structure |
| 104 | Storage grid |
| 105 | Storage column |
| 106 | Storage container |
| 106′ | Particular position of storage container |
| 107 | Stack |
| 108 | Rail system |
| 110 | Parallel rails in first direction (X) |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels |
| | in first direction (X) |
| 201c | Drive means/wheel arrangement/second set of wheels |
| | in second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 304 | Gripping device |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 121 | Control system |
| X | First direction |
| Y | Second direction |
| Z | Third direction |

FIGS. 5-18

| | |
|---|---|
| (Xi, Yj) | Grid position |
| A, B, C, D, E, | Rectangular non-overlapping zones of grid |
| F, G, H, I, J, | positions in first direction |
| K, L | |
| 1, 2, 3, 4, 5, | Rectangular non-overlapping zones of grid |
| 6, 7, 8, 9 | positions in second direction |
| 500 | Rail System |
| 501 | Permanently blocked cell |
| 502 | Open cell |
| 601 | Space dependent blocked cell |
| 701, 702, 703, | Non-overlapping rectangular regions of grid |
| 704, 704, 706, | positions latitudinally extending in the |
| 707, 708, 709, | first direction |
| 710, 711, 712, | |
| 713, 714, 715 | |
| 716, 717, 718, | Non-overlapping rectangular regions of grid |
| 719, 720, 721, | positions longitudinally extending in the |
| 722, 723, 724, | second direction |
| 725, 726, 727 | |
| α1-α2 | Demarcation line |
| 1500 | Method start |
| 1501 | Creating a model |
| 1502 | Representing the rail system as a finite set |
| | of non-overlapping rectangular zones |
| 1503 | Determining overlap information |
| 1504 | Determining grid position zone information |
| 1505 | Deceiving a request for a route |
| 1506 | Determining the route |
| 1507 | Defining grid positions that are not accessible |
| | for a container handling vehicle |
| 1508 | Determining non-overlapping rectangular regions |
| | latitudinally extending in the first direction |
| 1509 | Determining non-overlapping rectangular regions |
| | longitudinally extending in the second direction |
| 1510 | Removing any region that falls completely within |
| | another region |
| 1511 | Generating zone graph |

1.-23. (canceled)

24. A method of determining a route for a container handling vehicle operating on a rail system of an automatic grid-based storage and retrieval system comprising a framework structure including the rail system, the rail system comprising a first set of parallel rails arranged in a first direction, and a second set of parallel rails arranged in a second direction which is perpendicular to the first direction, the rail system defining a plurality of grid positions each being identifiable by a first coordinate in the first direction and a second coordinate in the second direction, the method comprising, using a control system:
creating a model of the rail system, comprising
representing the rail system as a finite set of non-overlapping rectangular first zones of grid positions, each first zone latitudinally extending in the first direction, and a finite set of non-overlapping rectangular second zones of grid positions, each second zone longitudinally extending in the second direction, wherein the zones are positioned around grid positions that are not accessible by the container handling vehicle;
determining overlap information indicative of one or more regions of the rail system in which there is an overlap between a zone of the finite set of first zones and a zone of the finite set of second zones; and
determining grid position zone information by, for each grid position, determining in which of the finite set of first zones and/or the finite set of second zones the grid position is located;
receiving a request for a route for at least one container handling vehicle from a first grid position to a second grid position; and
determining the route for the at least one container handling vehicle from the first grid position to the second grid position using the model of the rail system.

25. The method of claim 24, comprising, determining, using the grid position zone information, that the route is a straight line between the first grid position and the second grid position, based on the first grid position and the second grid position being in a same one of the second zones and/or the first zones and respectively sharing either a same first coordinate or a same second coordinate.

26. The method of claim 24, comprising, determining, using the grid position zone information, that the route is a single-turn Manhattan route between the first grid position and the second grid position, based on the first grid position and the second grid position being in a same one of the second zones and/or the first zones and sharing neither a same first coordinate nor a same second coordinate.

27. The method of claim 24, comprising, determining, using the grid position zone information and the overlap information, that the route is a single-turn Manhattan route between the first grid position and the second grid position, based on the first grid position being in one of the first zones and the second grid position being in an overlapping one of the second zones or based on the first grid position being in one of the second zones and the second grid position being in an overlapping one of the first zones.

28. The method of claim 24, comprising, using the set of first zones, the set of second zones and the overlap information to generate a zone graph comprising nodes and edges, wherein the nodes represent the finite set of first zones and the finite set of second zones, and the edges represent the overlap information.

29. The method of claim 28, comprising,
determining, using the grid position zone information and the overlap information, that the first grid position and the second grid position are not in a same one of the first zones and/or second zones and not in overlapping ones of the first and second zones, and
determining the route between the first grid position and the second grid position using a graph traversal and path search algorithm on the zone graph,
optionally wherein the graph traversal and path search algorithm is an A* algorithm.

30. The method of claim 24, wherein representing the rail system as the set of first zones and the set of second zones comprises:
defining the grid positions that are not accessible by the container handling vehicle as blocked cells and grid positions accessible for the container handling vehicle as open cells;
determining a first set of non-overlapping rectangular regions of grid positions, each first region latitudinally extending in the first direction and defining a largest possible rectangle of continuous open cells uninterrupted by at least one blocked cell;
determining a second set of non-overlapping rectangular regions of grid positions, each second region longitudinally extending in the second direction and defining the largest possible rectangle of continuous open cells uninterrupted by at least one blocked cell;
determining the finite set of first zones by removing any region of the first set of regions that falls completely within a region of the second set of regions; and
determining the finite set of second zones by removing any region of the second set of regions that falls completely within a region of the first set regions,
optionally:
wherein determining the first set of regions comprises determining continuous sections of open cells extending in the first direction that are uninterrupted by a blocked cell, each continuous section having a start position having a first coordinate and a length defined by a number of open cells uninterrupted by a blocked cell;
wherein the largest possible rectangle of continuous open cells latitudinally extending in the first direction uninterrupted by a blocked cell comprises either a number of adjacent continuous sections having a start position with a same first coordinate and a same first length, or a single vertical continuous section; and
wherein determining the second set of regions comprises determining continuous sections of open cells extending in the second direction that are uninterrupted by a blocked cell, each continuous section having a start position having a second coordinate and a length defined by the number of open cells uninterrupted by a blocked cell;
wherein the largest possible rectangle of continuous open cells longitudinally extending in the second direction uninterrupted by a blocked cell comprises either a number of adjacent continuous sections having a start position with a same second coordinate and a same second length, or a single horizontal continuous section.

31. The method of claim 24, wherein defining grid positions that are not accessible by the container handling vehicle comprises:
determining one or more grid positions that have at least one physical dimension that is smaller than at least one physical dimension of the container handling vehicle; and
identifying the one or more grid positions as being not accessible by the container handling vehicle.

32. The method of claim 24, wherein the method comprises:
receiving a request for a route for a plurality of container handling vehicles from a plurality of respective first grid positions to a plurality of respective second grid positions;
determining a fastest route for each of the plurality of container handling vehicles from the plurality of respective first grid positions to the plurality of respective second grid positions using the model of the rail system;
determining, based on the fastest route for each of the plurality of container handling vehicles, an optimal container handling vehicle of the plurality of container handling vehicles for moving to the second grid position; and
instructing the optimal container handling vehicle to move to the second grid position.

33. A control system for determining a route for a container handling vehicle operating on a rail system of an automatic grid-based storage and retrieval system comprising a framework structure including the rail system, the rail system comprising a first set of parallel rails arranged in a first direction, and a second set of parallel rails arranged in a second direction which is perpendicular to the first direction, the rail system defining a plurality of grid positions each being identifiable by a first coordinate in the first direction and a second coordinate in the second direction, wherein the control system is adapted to perform a method comprising:
creating a model of the rail system, comprising
representing the rail system as a finite set of non-overlapping rectangular first zones of grid positions, each first zone latitudinally extending in the first direction, and a finite set of non-overlapping rectangular second zones of grid positions, each second zone longitudinally extending in the second direction, wherein the zones are positioned around grid positions that are not accessible by the container handling vehicle;
determining overlap information indicative of one or more regions of the rail system in which there is an overlap between a zone of the finite set of first zones and a zone of the finite set of second zones; and
determining grid position zone information by, for each grid position, determining in which of the finite set of first zones and/or the finite set of second zones the grid position is located;
receiving a request for a route for at least one container handling vehicle from a first grid position to a second grid position; and
determining the route for the at least one container handling vehicle from the first grid position to the second grid position using the model of the rail system.

34. The control system of claim 33, wherein the method comprises determining, using the grid position zone information, that the route is a straight line between the first grid position and the second grid position, based on the first grid position and the second grid position being in a same one of the second zones and/or the first zones and respectively sharing either a same first coordinate or a same second coordinate.

35. The control system of claim 33, wherein the method comprises determining, using the grid position zone information, that the route is a single-turn Manhattan route between the first grid position and the second grid position, based on the first grid position and the second grid position being in a same one of the second zones and/or the first zones and sharing neither a same first coordinate nor a same second coordinate.

36. The control system of claim 33, wherein the method comprises determining, using the grid position zone information and the overlap information, that the route is a single-turn Manhattan route between the first grid position and the second grid position, based on the first grid position being in one of the first zones and the second grid position being in an overlapping one of the second zones or based on the first grid position being in one of the second zones and the second grid position being in an overlapping one of the first zones.

37. The control system of claim 33, wherein the method comprises using the set of first zones, the set of second zones and the overlap information to generate a zone graph comprising nodes and edges, wherein the nodes represent the finite set of first zones and the finite set of second zones, and the edges represent the overlap information.

38. The control system of claim 37, wherein the method comprises
determining, using the grid position zone information and the overlap information, that the first grid position and the second grid position are not in a same one of the first zones and/or second zones and not in overlapping ones of the first and second zones, and
determining the route between the first grid position and the second grid position using a graph traversal and path search algorithm on the zone graph,
optionally wherein the graph traversal and path search algorithm is an A* algorithm.

39. The control system of claim 33, wherein representing the rail system as the set of first zones and the set of second zones comprises:
defining the grid positions that are not accessible by the container handling vehicle as blocked cells and grid positions accessible for the container handling vehicle as open cells;
determining a first set of non-overlapping rectangular regions of grid positions, each first region latitudinally extending in the first direction and defining a largest possible rectangle of continuous open cells uninterrupted by at least one blocked cell;
determining a second set of non-overlapping rectangular regions of grid positions, each second region longitudinally extending in the second direction and defining the largest possible rectangle of continuous open cells uninterrupted by at least one blocked cell;
determining the finite set of first zones by removing any region of the first set of regions that falls completely within a region of the second set of regions; and
determining the finite set of second zones by removing any region of the second set of regions that falls completely within a region of the first set regions.

40. The control system of claim 39,
wherein determining the first set of regions comprises determining continuous sections of open cells extending in the first direction that are uninterrupted by a blocked cell, each continuous section having a start position having a first coordinate and a length defined by a number of open cells uninterrupted by a blocked cell;
wherein the largest possible rectangle of continuous open cells latitudinally extending in the first direction uninterrupted by a blocked cell comprises either a number of adjacent continuous sections having a start position with a same first coordinate and a same first length, or a single vertical continuous section; and
wherein determining the second set of regions comprises determining continuous sections of open cells extending in the second direction that are uninterrupted by a blocked cell, each continuous section having a start position having a second coordinate and a length defined by the number of open cells uninterrupted by a blocked cell;
wherein the largest possible rectangle of continuous open cells longitudinally extending in the second direction uninterrupted by a blocked cell comprises either a number of adjacent continuous sections having a start position with a same second coordinate and a same second length, or a single horizontal continuous section.

41. The control system of claim 33, wherein defining grid positions that are not accessible by the container handling vehicle comprises:
determining one or more grid positions that have at least one physical dimension that is smaller than at least one physical dimension of the container handling vehicle; and
identifying the one or more grid positions as being not accessible by the container handling vehicle.

42. The control system of claim 33, wherein the method comprises:
receiving a request for a route for a plurality of container handling vehicles from a plurality of respective first grid positions to a plurality of respective second grid positions;
determining a fastest route for each of the plurality of container handling vehicles from the plurality of respective first grid positions to the plurality of respective second grid positions using the model of the rail system;
determining based on the fastest route for each of the plurality of container handling vehicles an optimal container handling vehicle of the plurality of container handling vehicles for moving to the second grid position; and
instructing the optimal container handling vehicle to move to the second grid position.

43. A computer program product comprising instructions that, when performed on a control system, cause the control system to perform a method comprising:
creating a model of a rail system, comprising
representing the rail system as a finite set of non-overlapping rectangular first zones of grid positions, each first zone latitudinally extending in a first direction, and a finite set of non-overlapping rectangular second zones of grid positions, each second zone longitudinally extending in a second direction, wherein the zones are positioned around grid positions that are not accessible by a container handling vehicle;
determining overlap information indicative of one or more regions of the rail system in which there is an overlap between a zone of the finite set of first zones and a zone of the finite set of second zones; and
determining grid position zone information by, for each grid position, determining in which of the finite set of first zones and/or the finite set of second zones the grid position is located;
receiving a request for a route for at least one container handling vehicle from a first grid position to a second grid position; and
determining the route for the at least one container handling vehicle from the first grid position to the second grid position using the model of the rail system.
